(19) United States
(12) Patent Application Publication
(10) Pub. No.: US 2008/0060918 A1
(43) Pub. Date: Mar. 13, 2008

(54) Non- contact button system

(75) Inventor: Huihua Kenny Chiang, Taipei City (TW)

Correspondence Address: BIRCH STEWART KOLASCH & BIRCH, PO BOX 747, FALLS CHURCH, VA, 22040-0747, US

(73) Assignee: NATIONAL YANG-MING UNIVERSITY

(21) Appl. No.: 11/518,121

(22) Filed: Sep. 11, 2006

(51) Int. Cl. H01J 47/00

(52) U.S. Cl. 200/61.02

(57) ABSTRACT

A non-contact button system for controlling an electronic device comprising a substantially rigid front plate having a front surface and an inner housing located inner or outward from the front surface having an open spacing suitable for a finger or finger-sized object to insert into without physical contact with said inner housing. Within said inner housing, there are a light emitting element and a light receiving element. Said light receives element receiving light from said light emitting element as first status. Operator inserts a finger or finger-sized object into said open spacing to define second status and different statuses generating different electronic signals to control the electronic device.

### BACKGROUND OF THE INVENTION

The present invention relates to a non-contact button system for controlling electronic devices.

The switching system used to operate an electronic device is usually given by pressing push buttons placed near the controlled device for example the elevator cars. The signal issued by a push button is transmitted directly, or after processing, to the controlled system. In practical solutions, the push buttons can be implemented in various ways and, in normal conditions and if properly used, the solutions employed generally work without problems.

In certain environments and certain situations, the push buttons is not preferable due to public health consideration. In hospitals, factories, or infectious labs, the users are concerned for direct contact of any button. In such case, a non-contact button is preferred, in addition to the traditional touch button panel. Therefore a non-contact button is needed for the usage in the protected area.

There are several solutions in this field which aim at solving the problem referred to above and producing a non-contact buttons. However, the existing solutions are either subject to false activation or too complicated.

### SUMMARY OF THE INVENTION

The first object of the present invention is to provide a user friendly non-contact button system that can replace or work together with the current contact button system in situations which can be expected in practice. The present invention uses the theory of optical interacting with a finger or other object to activate the operation. The further object of the present invention to provide a low false activation rate. The present invention has advantages over the traditional non-contact button that relies on the transmitting and receiving of the light on the same front plane surface; any unintended close approach to the front surface may falsely activate the traditional non-contact button.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The accompanying drawings, which are incorporated in and constitute a part of this specification, illustrate several aspects of the invention and together with the description, serve to explain the principle of the invention. In the drawings:

FIG. 1 is a non-contact button system with a controlled electronic device.

FIG. 2 is a non-contact button system.

FIG. 3 is a front view of the non-contact button system.

FIG. 4 is a side view to describe one status of the non-contact button system.

FIG. 5 is another status of the non-contact button system.

FIG. 6 is the other embodiment in present invention.

FIG. 7 is another status of the other embodiment in present invention.

### DESCRIPTION OF THE EMBODIMENTS

Reference will now be made in detail to the exemplary aspects of the invention, examples of which are illustrated in the accompanying drawings. Wherever possible, the same reference numbers will be used throughout the drawings to refer to the same or like parts.

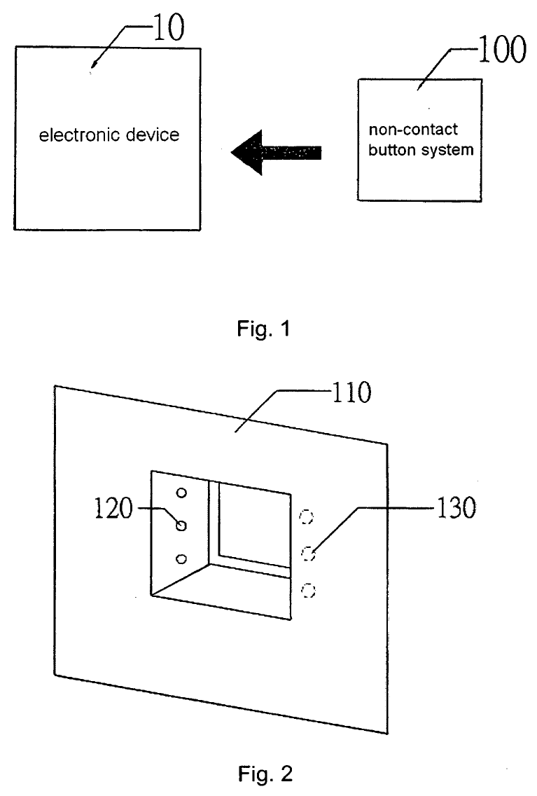

FIG. 1 illustrates an exemplary non-contact button system 100 with a controlled electronic device 10. The device 10 may be an equipment or elevator car set up in the hospital, factory, or labs. The requirement of the contact with operators causes a lot concerns when these buttons are used in hospitals or infectious environments. By connecting with the non-contact button system 100, it can reduce the chances of contacting contaminant or infectious materials when operating such device 10.

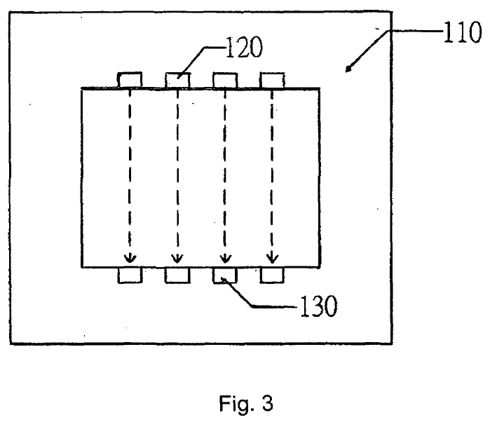

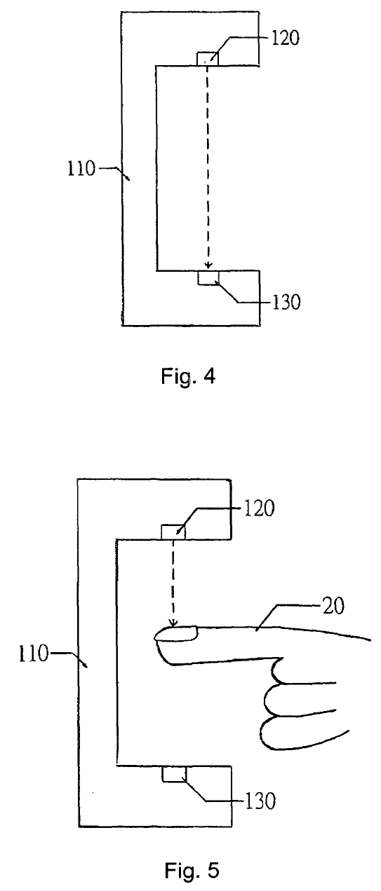

FIG. 2 shows the non-contact button system 100 in more detailed view. The front plate 110 of the non-contact button system 100 is made of a fairly rigid material, e.g. sheet metal of a thickness of one or two millimeters. For the operation of the non-contact button system 100, it makes no difference if the front plate 110 is implemented as a part integrated with the plate structure of the controlled device 10 or landing wall or as a separate plate. The front plate 110 has an inner housing. The inner housing includes at least two side surfaces, two of which facing each other. One side surface has light sourcing 120 and the other side surface has light detector 130. As shown in the FIG. 3 for the front view of the non-contact button system 100, light sourcing 120 emits light beam toward the other side surface; light detector 130 passively receives the light beam. FIG. 4 shows a side view to describe one status of the non-contact button system 100 on action. FIG. 5 shows another status of the non-contact button system 100. The depth of inner housing could be one to three centimeters so that it is enough to accept a least one human finger. FIG. 5 shows a human finger inserted into such spacing and blocks or interferes the transmission of light beams. As a result, light detector 130 receives fewer light even no light from the light sourcing 120. It defines another status of the non-contact button system 100.

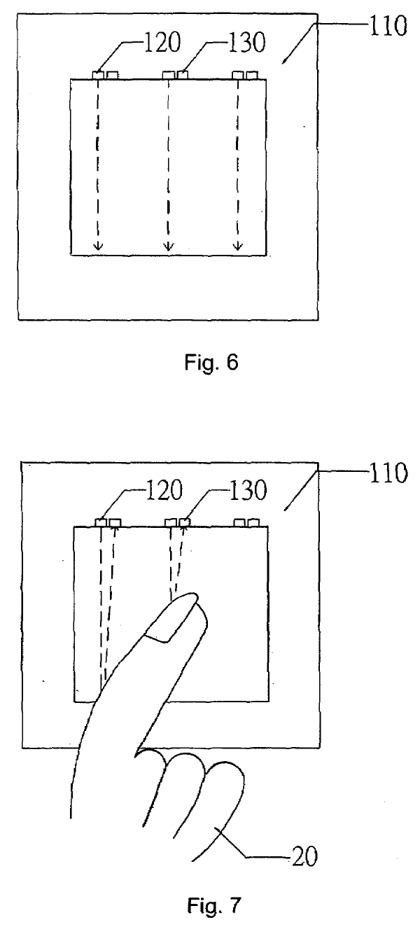

FIG. 6 illustrates the other embodiment in present invention. In this embodiment, light sourcing 120 and light detector 130 are located in the same surface of the inner housing. The light sourcing 120 and light detector 130 could be arranged one by one as indicated in FIG. 6. FIG. 6 shows one status of non-contact button system 100 where the light detector 130 receives less light beam from light sourcing 120 as compared to another status which is going to be addressed. To prevent the interference effects from the light scattering and reflection from the opposite surface, the emitting and receiving angle of the light source and detector could be adjusted. Some light absorbing materials can be placed on the opposite surface to reduce the backscattered light interference. FIG. 7 illustrates another status of this embodiment. While inserting at least one finger, light beam is reflected directly onto the light detector 130. The spacing distance between each light sourcing 120 and light detector 130 could be adjusted according to the size of human finger or the inserting object so that the light detector 130 could receive maximum reflection light. It is preferable to ask operator to insert their fingers with their nails abutting to the light sourcing 120 because the nail has better light reflection effect than the ball of the finger. It is obvious to a person skilled in the art that the front plate 110 may also be transparent or translucent in the manner of smoked glass, for example, a plate made of hard translucent plastic. It is further obvious to a skilled person that light sourcing 120 could be visible light, near-infrared light, or infrared light sources.

It is also obvious to a person skilled in the art that the whole system could be embedded inside the wall (concave) or stands against the wall without destroying the wall structure (convex). Taking FIG. 2 for further description, the light sourcing 120 and light detector pairs could be either positioned below the front plate 110 or above the front plate 110.

In both embodiments, two statuses generate at least two different logic statuses in electronic circuits so as to activate the controlled electronic device 10. The threshold level of each triggering logic statuses in different embodiments could be decided and adjusted by a person skilled in the art. Moreover, in all embodiments, the light sourcing 120 is always on, therefore it is reasonable for a person skilled in the art to efficiently control the power consumption of the non-contact button system 100 by reducing the power of the light sourcing 120 and increase the sensitivity of light detector 130. By implementing the present invention could not only prevent touching the unnecessary contaminant or infectious materials on the traditional push button surface but also reduce the false activation of equipments in the traditional non-contact button system.

The invention has been described above by the aid of some of its embodiments. However, the presentation is not to be regarded as limiting the sphere of patent protection, but instead the embodiments of the invention may vary within the limits defined by the following claims.

What is claimed is:

1. A non-contact button system for controlling an electronic device comprising:
a substantially rigid front plate having a front surface;
an inner housing located in the front surface having an open spacing suitable for a finger or finger-sized object to insert into without physical contact with said inner housing;
a light emitting element and a light receiving element located within said inner housing, thereby said light receiving element receiving light from said light emitting element as first status;
whereby, by inserting a finger or finger-sized object into said open spacing defining second status;
whereby, different statuses generating different electronic signals to control the electronic device.

2. The non-contact button system according to claim 1, wherein said light emitting element emit one of these light sourcing: visible light, near-infrared light, or infrared light and said light receiving element detects the power of corresponding light sourcing.

3. The non-contact button system according to claim 2, wherein said light receiving element generates electronic signals responding to a level of the light power.

4. The non-contact button system according to claim 3, wherein said electronic device is in activation status while electronic signals is greater than a predetermined value.

5. The non-contact button system according to claim 3, wherein said electronic device is in activation status while electronic signals is less than a predetermined value.

6. The non-contact button system according to claim 1, wherein said light emitting element and said light receiving element located on the opposing side of said inner housing, whereby light transmitted through said opening space from said light emitting element to said light receiving element.

7. The non-contact button system according to claim 6, wherein said light is blocked in transmission in second status, thereby light receiving element receiving less light than first status.

8. The non-contact button system according to claim 1, wherein said light emitting element and said light receiving element located on the same side of said inner housing, whereby light receiving element could not directly receive light transmitted from said light emitting element.

9. The non-contact button system according to claim 8, wherein said light is reflected by inserted finger or object in second status, thereby light receiving element receiving more light than first status.

10. The non-contact button system according to claim 1, wherein said front plate is attached to an elevator car wall or a landing wall by fixing elements.

11. The non-contact button system according to claim 1, wherein said non-contact button system further include a push button.
